(19) United States
(12) Patent Application Publication
(10) Pub. No.: US 2025/0312693 A1
(43) Pub. Date: Oct. 9, 2025

(54) METHODS AND COMPUTATIONAL PIPELINE FOR FLIGHT SIMULATOR HOST SIGNAL CALIBRATION

(71) Applicant: ROCKWELL COLLINS, INC., Cedar Rapids, IA (US)

(72) Inventors: Rishabh KAUSHIK, Cedar Rapids, IA (US); David OTTLEY, Cedar Rapids, IA (US); John Olav HARALDSTAD, Cedar Rapids, IA (US); Ankur RATHORE, Cedar Rapids, IA (US)

(73) Assignee: ROCKWELL COLLINS, INC., Cedar Rapids, IA (US)

(21) Appl. No.: 18/627,911

(22) Filed: Apr. 5, 2024

(51) Int. Cl. A63F 13/358; A63F 13/52; A63F 13/803; G06T 19/20

(52) U.S. Cl. CPC A63F 13/358; A63F 13/52; G06T 19/20; A63F 13/803; A63F 2300/8082; G06T 2219/2004

(57) ABSTRACT

A virtual or mixed reality system includes a Head Mounted Display (HMD) that receives content from a game engine. The game engine receives images from a host. The host operates at a fixed sampling rate while the HMD may operate at a variable refresh rate that differs from the rate for the host. The game engine provides updates to an item in the images having one or more features. The features have position or angle values that change with each update from the host. The game engine uses a multi-point extrapolation process and metaheuristics to provide updated or extrapolated position values for the item to the HMD.

### FIELD OF THE INVENTION

The present invention relates to updating a positional value for a computational pipeline for flight simulator host signal calibration. More particularly, the present invention provides a game engine-based metaheuristic computational pipeline for flight simulator host signal calibration with variable refresh rate head mounted display technologies.

### DESCRIPTION OF THE RELATED ART

Host with a fixed 60 Hz sampling rate is used to update the eyepoint on the image generator in a synchronous manner. This approach is not suitable for variable refresh rate devices like Mixed Reality (MR) or virtual reality (VR) headsets. The host position updates are sent at a fixed rate of 60 Hz, while the device operates at a non-deterministic 90 Hz refresh rate. This aspect of updates to the headsets results in motion jitters during flight simulation and training.

There is a need to provide the updates from the image generators in a manner that provides a smooth flight simulation.

### SUMMARY OF THE INVENTION

A method is disclosed. The method includes receiving a position value for a feature within a rendered entity for a virtual reality environment over a network. A latency within the network varies. The method also includes updating the position value for the feature by retrieving a heuristic time difference value from a plurality of heuristic time difference values that correspond to variances within the latency of the network. The method also includes updating the position value by determining an extrapolated value using the heuristic time difference value. The method also includes updating the position value by modifying the position value with the extrapolated value to generate an updated position value for the feature. The method also includes transmitting the updated position value for the feature within the network. The updated position value enhances smoothness of updating a position of the rendered entity in the virtual reality environment.

A method is disclosed. The method includes receiving a position value for a feature used in a virtual reality environment. A sampling rate for the position value varies. The method also includes updating the position value for the feature by retrieving a heuristic time difference value from a buffer of a plurality of heuristic time difference values. The method also includes updating the position value by determining an extrapolated value using the heuristic time difference value. The method also includes modifying the position value with the extrapolated value to generate an updated position value for the feature. The method also includes transmitting the updated position value for the feature for use in the virtual reality environment.

A non-transitory computer-readable medium having stored thereon processor-executable instructions for performing operations is disclosed. The operations include receiving a position value for a feature used in a virtual reality environment. A sampling rate for the position value varies. The operations also include updating the position value by retrieving a heuristic time difference value from a buffer of a plurality of heuristic difference time values. The operations also include updating the position value by determining an extrapolated value using the heuristic time difference value. The operations also include updating the position value by modifying the positional value with the extrapolated value to generate an updated position value for the feature. The method also includes transmitting the updated position value for the feature for use in a virtual reality environment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and which some features may be exaggerated and some features may be omitted or may be represented schematically in the interest of clarity. Like reference numerals in the drawings may represent and refer to the same or similar element, feature, or function. In the drawings:

FIG. 1 illustrates a block diagram of augmented reality system having a game engine, a host, and a head mounted display according to the disclosed embodiments.

FIG. 2 illustrates a block diagram of the game engine according to the disclosed embodiments.

FIG. 3 illustrates a block diagram of the data flow within an extrapolation module for the game engine using time difference values according to the disclosed embodiments.

FIG. 4 illustrates a flowchart for updating a position value for a feature within a rendered entity for a Head Mounted Display according to the disclosed embodiments.

### DETAILED DESCRIPTION OF THE PREFERRED EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The disclosed embodiments provide a metaheuristic technique coupled with a unique extrapolation technique to implement an approach that provides features for variable refresh rate products, such as a virtual or mixed reality headset. The technique allows a system to reutilize the host pipeline to provide smooth flight simulation within the head mounted display. These features result in cost savings and eliminates code redundancy. The capability also allows the operation of both multi-channel and Extended Reality (XR) mode, with all controlled by a single host.

Smoothness of the flight simulation is enhanced while being independent of the virtual reality camera within a scene that exhibits the six (6) degrees of freedom facilitated by the head mounted display (HMD) technology. As a result, the scene already is rendered. This feature assists in delivering a seamless flight experience controlled by the host. It also may eliminate the jerky movements caused by inconsistent processing of position updates between frames that are running at an inconsistent rate.

The disclosed embodiments is separate from other aspects of the system to facilitate the use of devices with higher refresh rates, even those exceeding 90 Hz. Further, the disclosed embodiments may adapt to various position update frequencies, or sampling rates, that differ from the commonly used 60 Hz rate, which may be imposed by the limitations on current display technologies.

The disclosed embodiments may utilize the time when the position updates are read from the network, which differs from the true time, or timestamp, when the position updates are generated at the host. To account for the time discrepancy caused by the network delay, the disclosed embodiments implement metaheuristics by averaging the differences between these timestamps from previous frames when the position updates are retrieved from the network. The technique uses calculated values close to “true time” values, resulting in improved quality of providing the simulation data to the HMD.

Features include using the previous calculated eyepoint position (latitude, longitude, altitude) and rotation (heading, pitch, roll). These also include capturing the time difference between two host position packets when the packets are read from the network right after their transmission by the host. A circular queue captures the values for the last 127 frames (can be variable) and performs a running average on the values. This metaheuristic technique provides a high precision timestamp value in close approximation to the operating system's internal clock used by the host. This feature allows for an accurate extrapolated position calculation. Features also include capturing the time difference between current frame and time when the position packet is read off the network.

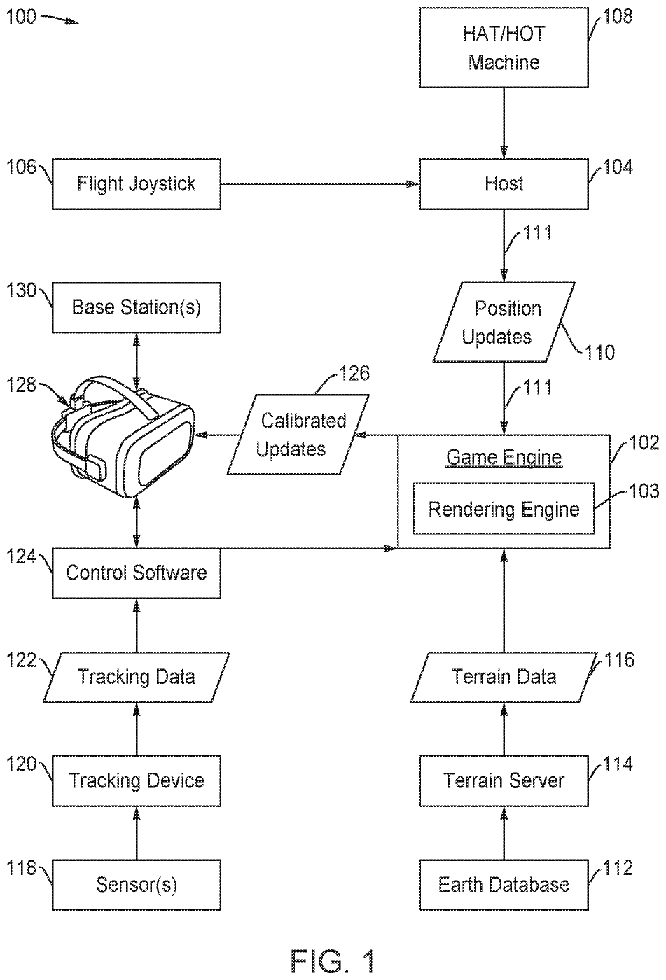

FIG. 1 depicts a block diagram of augmented reality system 100 having a game engine 102, a host 104, and a Head Mounted Display (HMD) 128 according to the disclosed embodiments. System 100 may be a virtual reality or mixed reality system that provides data and information to HMD 128. The data and information may be related to flight simulation in that a user of HMD 128 experiences a flying experience without having to use an actual aircraft. System 100 also provides flight simulation without the need for a large flight simulation system.

Host 104 is a simulation host device that provides eyepoint position and velocity information to game engine 102 at a sampling rate. Host 104 may receive data from flight joystick 106. Host 104 also receives data from HAT/HOT machine 108. HAT/HOT machine 108 provides height above terrain (HAT) and height of terrain (HOT) information as requested by host 104. Host 104 may include a scalable architecture to enable a common structure between all types and levels of simulation devices. Host 104 may connect live, virtual, and constructive resources across different networks and protocols.

Host 104 provides position updates 110 using the information provided by flight joystick 106 and HAT/HOT machine 108. Position updates 110 may include a positional value related to a feature within a rendered image to HMD 128. The feature may be the eyepoint position for use by game engine 102. Position updates 110 may be provided to game engine 102 at 60 Hz, or 0.01667 seconds per update. Game engine 102 uses position updates 110 plus additional information to provide calibrated updates 126 to HMD 128.

System 100 also includes earth database 112. Earth database 112 may store three-dimensional (3D) data for ground features. It provides this information to terrain server 114. Terrain server 114 provides terrain data 116 to game engine 102. Terrain data 116 includes data for ground level textures and features that define the location or environment currently in use by system 100.

System 100 also includes virtual reality tracking device 120. Tracking device 120 may receive data from one or more sensors 118. Tracking device 120 may be a basestation that determines the location of sensors 118 as they move within space. In some embodiments, tracking device 120 includes two or more basestations connected to multiple sensors. Using the data from the basestations and sensors 118, tracking device 120 calculates the orientation, velocity, and angular velocity of the tracked object subject to an update rate. Within system 100, HMD 128 may be tracked object. By utilizing the positions of the tracked markers and the established geometry of the VR setup, the system can determine the user's position and movements in relation to the reference points given by the external sensors 118. This can sometimes be in addition to the inertial measurement units present in the HMD 128 used for tracking the position and orientation through path integration.

Tracking device 120 provides tracking data 122 for the one or more tracked objects to control software 124 for HMD 128. Control software 124 allows an administrator to control what is being shown on HMD 128 as well as access settings and presentation tools. Control software 124 provides tracking data 122 to game engine 102 and HMD 128.

Game engine 102 receives position updates 110, terrain data 116, and tracking data 122 to construct a virtual or mixed reality experience using HMD 128. Game engine 102 includes a rendering engine 103 for rendering graphics used by game engine 102. Game engine 102 may provide a set of reusable components to allow the generation of content for HMD 128. It may take data stored at earth database 112 and data provided by host 104 and tracking device 120 and processes the data to create the content. Part of this data is position updates 110 for eyepoint location within HMD 128.

Game engine 102 provides content for HMD 128. HMD 128 is a display device with stereo rendering at a variable refresh rate. HMD 128 may be used in virtual or mixed reality environments. Along with the content, game engine 102 also provides calibrated updates 126. HMD 128 may have a refresh rate of 90 Hz, or 0.01111 seconds. This refresh rate is faster than the rate of position updates 110 provided by host 104 to game engine 102. Thus, HMD 128 requests updates for a position faster than the data provided by host 104 to game engine 102. This refresh rate also may be variable in that it is not always exactly 90 Hz.

System 102 also includes one or more base stations 130. Base stations 130 may be tracking base stations or, ‘lighthouses’. These are devices that work with HMD 128 to calculate position, orientation and perform calibration of the HMD in real-time. Base stations 130 employ wireless pulses and laser lines to meticulously track the precise position of the HMD 128 as it scans the room.

Game engine 102 may be connected to host 104 by network 111. Packets of data, or position updates 110, are placed on network 111 and delivered to game engine 102. There may be some delay between these two actions. Further, there may be delay from when a frame is received having position updates 111 as well. Other components within system 100 also may be connected to network 111.

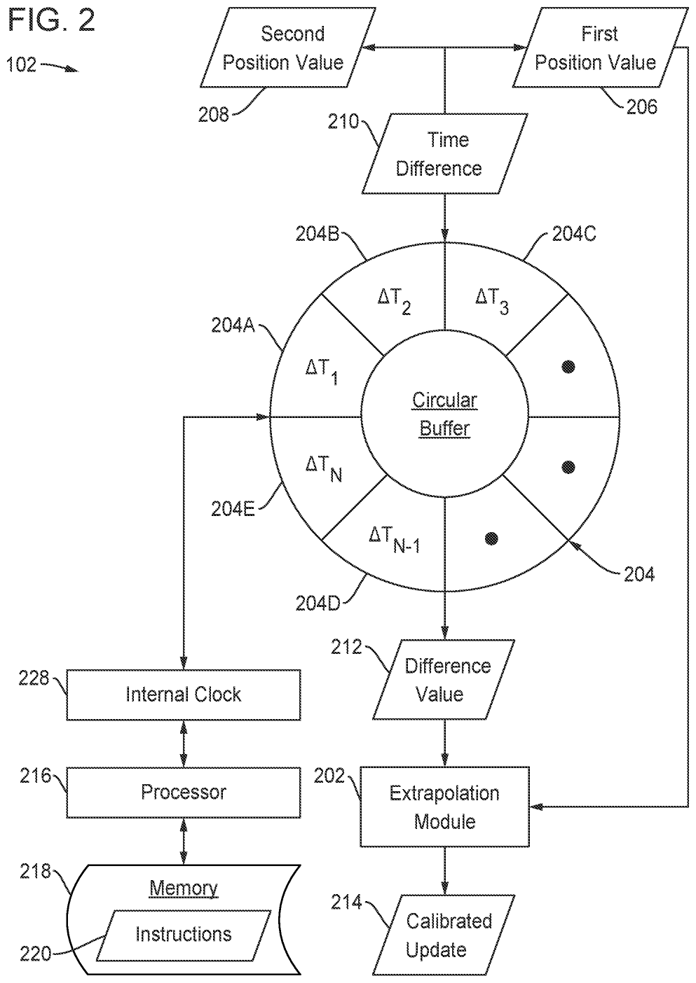

FIG. 2 depicts a block diagram of game engine 102 according to the disclosed embodiments. Game engine 102 may include additional components. The disclosed components relate to features used within system 100 to provide calibrated updates to HMD 128. Game engine 102 may include at least one processor 216 and memory 218. Processors 216 are configured to execute instructions 220 stored in memory 218. Instructions 220 further configure processors 216 to provide the functionality disclosed here. Processors 216 and memory 218 may be used to launch game engine 102, and provide the processing capabilities used by the other components disclosed herein. Processors 216 also may be connected to an internal clock 228.

Game engine 102 includes extrapolation module 202. Extrapolation module 202 receives position updates 110, including first position value 206 and second position value 208, from host 104. The position updates are for a feature within a rendered image for HMD 128. The feature may correspond to an eyepoint position within the image yet also may include other features as well. Potential features include latitude, longitude, altitude, heading, pitch, or roll of the item position within the image. The item position changes as images are rendered. Host 104 provides position updates 110 based on information received from flight joystick 106 and HAT/HOT machine 108.

Extrapolation module 202 updates or calibrates the position update to account for the variance in the refresh, or frame, rate to HMD 128. For example, the refresh rate for HMD 128 may be 90 Hz, but, due to rendering variances, the actual refresh rate differs over time. Thus, the refresh rate may vary between 80-90 Hz. Extrapolation module 202 executes a process to account for this difference using a heuristic time difference value 212 read from circular buffer 204. Thus, the disclosed embodiments account for host 104 running at a fixed frame rate while HMD 128 may run at a variable frame rate.

It should be noted that these values are used for examples only. The frame or refresh rate of devices connected to game engine 102 may differ from those provided above. Further, the refresh or frame rates for hose 104 and HMD 128 may be higher or lower than the amounts provided herein. For example, HMD 128 may have a refresh rate between 120 Hz or higher.

Extrapolation module 202 receives time difference value 212 and uses this value to determine calibrated update 214 to a received position update. Calibrated update 214 may be the extrapolated or resolved position or angle of the feature desired for this frame to HMD 128. Extrapolation module 202 executes a process using time difference value 212 along with other information to generate the updated position or angle. This process may use multi-point extrapolation and metaheuristics.

Time difference value 212 is provided by circular buffer 204. Circular buffer 204 may capture the time differences between two host position packets when they are read off network 111 right after their transmission by host 104. For example, first position value 206 may be read off network 111 by game engine 102 at time T_{R}. The time that first position value 206 is placed on network 111 differs from time T_{R}, and should occur prior to time T_{R}. Second position value 208 is read off network 111 by game engine 102 at time T_{R+1}. Again, the frame associated with second position value 208 is placed on network 111 at a different time prior to T_{R+1}. Circular buffer 204 captures time difference 210 between the respective times that first position value 206 and second position value 208 were read off the network, or T_{R+1}−T_{R}.

Time difference 210 is placed in circular buffer 204, which acts as a first in, first out buffer. Circular buffer 204 is a circular queue that captures time differences 210 for a number of preceding frames. For example, circular buffer 204 includes time differences 210 for the previous 127 frames, or 127 position values, received over network 111. Circular buffer 210 performs a running average on the time differences 210 in the circular buffer 204 to determine difference value 212 that is provided to extrapolation module 202. The metaheuristic technique provides a high precision timestamp value in close approximation to an internal clock 228 of the operation system of game engine 102.

Time difference value 212 is determined according to the following equation:

$${T}_{DIFF} = ( {\sum }_{i}^{N} Δ Ti ) / N , wherein i = 1 to N buffer entries . \\ The total of the time difference values \\ may be divided by number of buffer entries . \qquad Equation 1$$

The value for time difference value 212 changes over time as packets of position updates 110 are received at game engine 102. Time difference value 212, therefore, is frame rate agnostic and may vary according to the differences on network 111.

Circular buffer 204 may include a number N of entries to store captured time differences 210. As shown, one entry 204A may include ΔT₁, which may represent the latest time difference 210 captured. To make room for ΔT₁, the oldest time difference, or T_{N+1}, may be deleted from circular buffer 204. The new time difference also pushes the previous newest time difference, or ΔT₂, to entry 204B. The same occurs for time difference ΔT₃ to entry 204C, and so on to entry 204D for time difference ΔT_{N-1} and entry 204E for time difference ΔT_{N}. Thus, as time differences 210 are captured, entries 204A-E are updated accordingly.

Extrapolation module 202 reads difference value 212 to use it in determining calibrated value 214 for the feature of the image. Extrapolation module 202 may provide calibrated value 214 to rendering engine 103 of game engine 102 to be used in rendering an image with calibrated updates 126 to HMD 128.

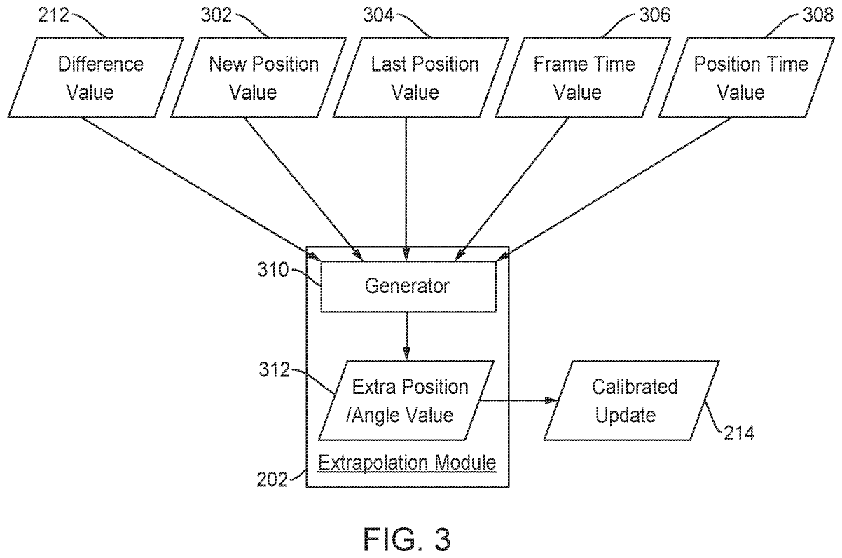

FIG. 3 depicts a block diagram of the data flow within extrapolation module 202 for game engine 102 using time difference values 212 according to the disclosed embodiments. FIG. 3 may refer to FIGS. 1 and 2 for illustrative purposes. Extrapolation module 202 receives various types of data to provide an extrapolated or resolved value for a feature within the rendered image being sent to HMD 128.

In addition to time difference value 212 from circular buffer 204, extrapolation module 202 receives additional data regarding times and position values read off network 111. For example, new position value 302 for a feature, such as latitude, longitude, altitude, heading, pitch, or roll of an item within a frame may be read off network 111. New position value 302 may be similar to first position value 206 or second position value 208 disclosed above. New position value 302 is the value, or Xn, of the feature in the new frame received at game engine 102.

Last position value 304 is the last value of a position value for a previous frame received off network 111. Last position value 304, or XL, may differ from new position value 302, or Xn. Frame time value 306 also may be received. Frame time value 306, or Tf, relates to the time the new frame was placed on network 111 by host 104. Position time value 308, or TWn, may relate to the time when the packet having new position value 302 was read off network 111.

If Xf is extrapolated position or angle value 312 for the current frame, then it may be determined as

$$Xf = [ ( X n - XL ) / ( TDV ) ] * [ Tf - TWn ] + Xn , \\ where TDV is time difference \\ value 212 from circular buffer 204. \qquad Equation 2$$

Equation 2 may be implemented by generator 310 to generate updated extrapolated position or angle value 312. Value 312 is included in calibrated update 214 which may be used to generate calibrated updates to the current frame. Use of time difference value 212 provides the features disclosed above with regards to smoothness and a better experience using HMD 128.

It should be noted that the term position value also includes an angle value, should the feature include an angular parameter. Thus, value 312 may be determined using angle values for values 302 and 304.

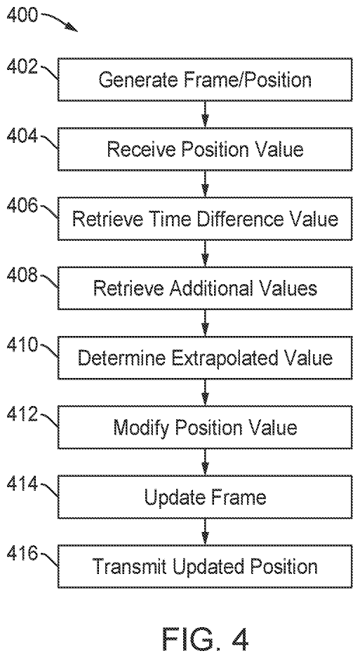

FIG. 4 depicts a flowchart 400 for updating a position value for a feature within a rendered image for HMD 128 according to the disclosed embodiments. Flowchart 400 may refer to FIGS. 1-3 for illustrative purposes. Flowchart 400, however, is not limited to the embodiments disclosed by FIGS. 1-3.

Step 402 executes by generating an image frame, or rendered entity, at host 104. A time may be captured for when the image is placed on network 111. The image may include a position update 110 for an item in the image, such as eyepoint location. The position update also includes features, such as latitude, longitude, altitude, heading, pitch, and roll, for the item. Step 404 executes by receiving position update 110 at game engine 102 off network 111. Again, a time may be captured when the position update 110 is received off network 111. Position update 110 may include first position value 206. A sampling value for the position value varies.

Step 406 executes by retrieving time difference value 212 from circular buffer 204. Time difference value 212 may be the summation of time differences 210 captured within game engine 102 and placed in circular buffer 204 divided by the number of captured time differences. These features are disclosed above. Use of circular buffer 204 and time differences 210 allows for variances of rates or latency over network 111 and within system 100.

Step 408 executes by retrieving, or capturing, additional values with regard to the received position value or image frame. These values may include new position value 302 for the feature, last position value 304 for the feature, frame time 306 of when the received image was placed on network 111, and position time value 308 of when first position value 206 was read off network 111.

Step 410 executes by determining extrapolated position or angle value 312 using the values disclosed in steps 406 and 408, which also include time difference value 212 determined using the running average of the circular buffer 204. As disclosed above, a position value may include an angle value for the item in the image. Equation 2, disclosed above, may be used to determine the extrapolated value. Step 412 executes by modifying first position value 206 with extrapolated value 312 to generate an updated position value, or calibrated update 214, for use with the image being provided from game engine 102.

Step 414 executes by updating the current frame with the calibrated update 214 to be included with calibrated updates 126 for the current frame. Step 416 executes by transmitting the updated position with the image to HMD 128. Thus, the position of the item, such as an eyepoint, is updated for images where host 104 refreshes at a fixed rate and HMD 128 refreshes at a variable rate by taking into account time differences between position packets within network 111.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

1. A method comprising:
receiving a position value for a feature within a rendered entity for a virtual reality environment over a network, wherein a latency within the network varies;
updating the position value for the feature by
retrieving a heuristic time difference value from a plurality of heuristic time difference values that correspond to variances within the latency of the network,
determining an extrapolated value using the heuristic time difference value, and
modifying the position value with the extrapolated value to generate an updated position value for the feature; and
transmitting the updated position value for the feature within the network, wherein the updated position value enhances smoothness of updating a position of the rendered entity in the virtual reality environment.

2. The method of claim 1, further comprising generating the heuristic time difference value using a circular buffer, wherein the circular buffer stores a plurality of heuristic time difference values.

3. The method of claim 2, further comprising generating an actual time difference value for each of the plurality of heuristic time difference values by determining a time difference between two host position packets for the respective heuristic time difference values.

4. The method of claim 3, wherein the time difference is determined by retrieving the two host position packets from the network.

5. The method of claim 4, further comprising calculating a period of time between when a first host position packet of the two host position packets is retrieved from the network and when a second host position packet of the two host position packets is retrieved from the network.

6. The method of claim 3, further comprising determining a total time difference value based on the actual difference values of the plurality of time values.

7. The method of claim 6, wherein the heuristic time difference value is based on the total time difference value and a number of the plurality of heuristic time difference values.

8. The method of claim 6, wherein the total time difference value varies over a period of time.

9. The method of claim 2, further comprising replacing the heuristic time difference value within the circular buffer with a new heuristic time difference value.

10. A method comprising:
receiving a position value for a feature used in a virtual reality environment, wherein a sampling rate for the position value varies;
updating the position value for the feature by
retrieving a heuristic time difference value from a buffer of a plurality of heuristic difference time values;
determining an extrapolated value using the heuristic time difference value, and
modifying the position value with the extrapolated value to generate an updated position value for the feature; and
transmitting the updated position value for the feature for use in the virtual reality environment.

11. The method of claim 10, further comprising replacing the heuristic time difference value within the circular buffer with a new heuristic time difference value.

12. The method of claim 10, wherein the feature having the updated position value is within a rendered image or entity.

13. The method of claim 12, wherein the position value is received over a network.

14. The method of claim 13, wherein the network is subject to the latency.

15. The method of claim 10, further comprising
generating an actual time difference value for each of the plurality of heuristic time difference values by determining a time difference between two host position packets for the respective heuristic time difference values, wherein the time difference is determined by receiving the two host position packets; and
calculating a period of time between when a first host position packet of the two host position packets is received and when a second host position packet of the two host position packets is received.

16. The method of claim 10, further comprising
generating an actual time difference value for each of the plurality of heuristic time difference values by determining a time difference between two host position packets for the respective heuristic time difference values; and
determining a total time difference value based on the actual difference values of the plurality of time values, wherein the heuristic time difference value is based on the total time difference value and a number of the plurality of heuristic time difference values.

17. A non-transitory computer-readable medium having stored thereon processor-executable instructions for performing operations comprising:
receiving a position value for a feature used in a virtual reality environment, wherein a sampling rate for the position value varies;
updating the position value for the feature by
retrieving a heuristic time difference value from a buffer of a plurality of heuristic difference time values;
determining an extrapolated value using the heuristic time difference value, and
modifying the position value with the extrapolated value to generate an updated position value for the feature; and
transmitting the updated position value for the feature for use in the virtual reality environment.

18. The non-transitory computer-readable medium of claim 17, further comprising instructions for performing operations including replacing the heuristic time difference value within the circular buffer with a new heuristic time difference value.

19. The non-transitory computer-readable medium of claim 17, further comprising instructions for performing operations including
generating an actual time difference value for each of the plurality of heuristic time difference values by determining a time difference between two host position packets for the respective heuristic time difference values, wherein the time difference is determined by receiving the two host position packets; and
calculating a period of time between when a first host position packet of the two host position packets is received and when a second host position packet of the two host position packets is received.

20. The non-transitory computer-readable medium of claim 17, further comprising instructions for performing operations including
generating an actual time difference value for each of the plurality of heuristic time difference values by determining a time difference between two host position packets for the respective heuristic time difference values; and
determining a total time difference value based on the actual difference values of the plurality of time values, wherein the heuristic time difference value is based on the total time difference value and a number of the plurality of heuristic time difference values.
